(19) United States
(12) Patent Application Publication
(10) Pub. No.: US 2021/0135554 A1
(43) Pub. Date: May 6, 2021

(54) NOVEL DOUBLE-STATOR COMBINED ELECTRIC MACHINE SUITABLE FOR ACHIEVING SENSORLESS CONTROL OF ABSOLUTE POSITION OF ROTOR

(71) Applicant: QINGDAO UNIVERSITY, Qingdao, Shandong (CN)

(72) Inventors: Ronggang NI, Qingdao, Shandong (CN); Shuxin NIE, Qingdao, Shandong (CN); Yawei WU, Qingdao, Shandong (CN)

(21) Appl. No.: 16/965,406

(22) PCT Filed: Nov. 27, 2019
(86) PCT No.: PCT/CN2019/121222

§ 371 Date: Jul. 28, 2020

(30) Foreign Application Priority Data
May 13, 2019 (CN) 201910391977.3

(51) Int. Cl. H02K 16/04; H02K 21/02; H02K 1/27

(52) U.S. Cl. CPC H02K 16/04; H02K 21/024; H02K 2213/03; H02K 2201/03; H02K 1/274

(57) ABSTRACT

A double-stator and electric machine suitable for achieving sensorless control of the absolute position of a rotor. An inner stator is fixed to a stationary shaft, an outer stator and the inner stator are concentric, and the above components form a stationary part of the electric machine. A rotor is assembled between the outer stator and the inner stator, and forms a rotating part of the electric machine with a moving shaft through a front rotor support. The rotating part is isolated from a front end cap through a front outer bearing. The rotating part is isolated from a back end cap through a back outer bearing after the rotating part is connected with a back rotor support. The moving shaft is isolated from the stationary shaft through an inner bearing.

### TECHNICAL FIELD

The present invention belongs to the field of electric machine equipment manufacturing technologies, and specifically relates to a novel double-stator combined electric machine suitable for achieving sensorless control of the absolute position of a rotor.

### BACKGROUND

To the high-tech device, such as the modern numerical control machine, the smart home device, the robot, etc., the electric machine driving system should have the ability of detecting the absolute position (also known as the mechanical angle position) of a rotor. Detection the common relative position (also known as the electrical angle position) can be achieved by not only a position sensor, but also the control without the position sensor; what's different is, the existing detection method of the absolute position of electric machine rotor is achieved by an absolute position sensor instead of position sensorless control due to the periodic symmetry of the internal electromagnetic structure of the electric machine. However, the absolute position sensor is very expensive and has complex encoding and signal transmission manners. Furthermore, the mounted position sensor occupies the axial space of the electric machine. So, the power density, the integration level and the reliability of the system are reduced.

A common synchronous machine has a single-stator single-rotor structure. Its internal electromagnetic period is p times of the mechanical period, wherein the p represents the number of pole pairs. Only when the p is equal to 1, the absolute position of the electric machine rotor is equal to its relative position; but in most of application fields, the p is an integer greater than 1. Because the common sensorless control can merely detect the electrical angle position information of the rotor, an electric machine with the p greater than 1 cannot obtain the absolute position of the rotor through the sensorless control. It can be seen: to achieve the sensorless control of the absolute position of the rotor, the electric machine must be improved based on electric machine topology without influencing the electric machine performances. The synchronous machine has multiple topology structures, wherein a double-stator structure is advantageous to improve the power density of the electric machine, expand the flux weakening range and the like. A double-stator synchronous machine has two stators and one rotor. An air gap exists between the stator and the rotor. Thus, the double-stator electric machine has two air gaps. To the existing double-stator synchronous machine, there are generally the same types and numbers of pole pairs of the electric machines corresponding to the two air gaps.

Limited to the periodicity of a magnetic circuit structure of the electric machine, researches on the sensorless control of the absolute position of the rotor are very rare, and only reported by Seoul National University in Korea. In these researches, the structures of a stator and a rotor of an electric machine are modified to generate asymmetry of the mechanical period; rotor magnetic poles with different outlines are designed, and a detection winding is added to the stator; then, in combination with a high-frequency voltage injection manner, the absolute position of the rotor is detected. However, the inductance of the winding and the counter-electromotive force harmonic wave are also simultaneously added when the asymmetry of the mechanical period is generated, thereby causing new problems of torque ripples, vibration noises and the like; and it is hard to balance the electric machine performances and the detection precision of the absolute position. Furthermore, the added detection winding occupies the space of the stator, which is against improvement of the power density.

In an aspect of the double-stator electric machine structure, the types and the numbers of pole pairs of the electric machines of the two air gaps are generally the same. Besides, there are the following combined structures: an electric machine structure combining an excited electric machine structure, a memory electric machine and a flux-switching electric machine, a double-stator electric machine structure capable of achieving the rotational linear motion, a double-stator electric machine structure with an integrated active bearing, etc. However, the above structures only aim to achieve high power density, wide speed regulation range or multiple-degree-of-freedom control, but cannot achieve the sensorless control of the absolute position of the rotor. Therefore, the present invention provides a novel double-stator combined electric machine suitable for achieving sensorless control of the absolute position of a rotor based on the electric machine topology.

### SUMMARY

The objective of the present invention is to provide a novel double-stator combined electric machine structure based on electric machine topology to overcome the above defects and solve the technical problems that the general synchronous machine and sensorless control cannot achieve absolute position detection of a rotor. The novel double-stator combined electric machine structure utilizes reasonable combinations of different types and pole pair numbers of electric machines to achieve the sensorless control of the absolute position of an electric machine rotor while improving the power density of an electric machine system.

To achieve the above objective, a novel double-stator combined electric machine suitable for achieving sensorless control of the absolute position of a rotor of the present invention is achieved by the following solution:

An electric machine housing sleeves an outer stator. The outer stator is limited by a retainer ring and then is tightly clamped by a front end cap and a back end cap. A stationary shaft and a small back end cap are mounted at the center of the back end cap. An inner stator is fixed to the stationary shaft, the outer stator and the inner stator are concentric, and the above components form a stationary part of the electric machine. A rotor is assembled between the outer stator and the inner stator, and forms a rotating part of the electric machine with a moving shaft through a front rotor support. The rotating part is isolated from the front end cap through a front outer bearing. The rotating part is isolated from the back end cap through a back outer bearing after the rotating part is connected with a back rotor support. The moving shaft is isolated from the stationary shaft through an inner bearing. The outer stator and the outer side of the rotor form an outer air-gap electric machine, and the inner stator and the inner side of the rotor form an inner air-gap electric machine. The type of the outer air-gap electric machine and the type of the inner air-gap electric machine may be formed by combining two types of the following electric machines or one type of the following electric machines in pairs: a permanent magnet synchronous machine (a brushless permanent magnet machine), a synchronous reluctance machine, a switched reluctance machine, an electrically excited synchronous machine, a hybrid excitation synchronous machine and the like; or the type of the outer air-gap electric machine and the type of the inner air-gap electric machine may be formed by combining one type of the above electric machines with a reluctance or wound type rotary transformer.

The numbers of pole pairs p1 and p2 of the two air-gap electric machines meet the following basic rule:

(1), p1≠p2, the greatest common divisors of the p1 and the p2 are equal to 1, and the p1 and the p2 are positive integers;

(2), |m·p1−n·p2|=1, the p1 and the p2 are positive integers, and the m and the n are positive integers.

The type of the electric machine of the present invention is a synchronous machine. The synchronous machine mainly includes a permanent magnet synchronous machine, a brushless permanent magnet machine, an electrically excited synchronous machine, a hybrid excitation synchronous machine, a synchronous reluctance machine, a switched reluctance machine, and a reluctance or wound type rotary transformer.

An arrangement manner of permanent magnets shown in the present invention can be radial arrangement, tangential arrangement and combined arrangement. The combined arrangement comprises U-shaped arrangement, V-shaped arrangement, W-shaped arrangement, and the other radial-tangential combined arrangement.

In the present invention, a cooling water channel may be opened in the housing and the stationary shaft, respectively; or according to the actual temperature increase situation, the water channel is not opened, but an air cooling manner, a natural cooling manner and the like are utilized. The present invention can also utilize variations of the other electric machine structures.

The electric machine topology provided by the present invention has a double-stator structure of a radial-magnetic-field electric machine, the direction of magnetic field of its air gap is radial, and the motion manner is rotation. Besides, the present invention can be also applied to a double-stator and multiple-stator structure of an axial-magnetic-field electric machine (also known as a disc-type electric machine), the direction of magnetic field of its air gap is axial, the stators and the rotor are disc-shaped, and the motion manner is also rotation. Besides the above rotating electric machines, the present invention is also applicable to a double-stator single-rotor linear electric machine structure (whose motion manner is the linear motion) and a planar electric machine structure (whose motion manner is the planar motion).

Compared with the prior art, the present invention has the following beneficial effects:

The objective of the present invention is to provide the electric machine structure suitable for achieving sensorless control of the absolute position of a rotor based on the electric machine topology. The electric machine topology provided by the present invention does not change the periodicity of an electric machine electromagnetic structure, namely not introducing the mechanical periodical harmonic wave. However, the present invention radially integrates the electric machine structures of different types and pole pair numbers based on the double-stator electric machine structure to increase the control dimension. The present invention obtains the absolute position of the rotor finally by conducting sensorless detection on the electrical angle positions of the two air gaps and then demodulating the detected electrical angle positions of the two air gaps. Therefore, the electric machine topology provided by the present invention has the advantages of high power density, high integration level, high reliability and the like while achieving the sensorless detection of the absolute position of the rotor. In conclusion, the main body of the electric machine has a simple structure, smart design concept, friendly application environment and wide market prospect.

### BRIEF DESCRIPTION OF THE DRAWINGS

FIG. 1 is a radial sectional view of a radial-magnetic-field double-stator combined electric machine of the present invention.

FIG. 2 is a radial cross sectional view of a double-stator combined electric machine combining two permanent magnet synchronous machines in the present invention.

FIG. 3 is a radial cross sectional view of a double-stator combined electric machine combining a permanent magnet synchronous machine and a synchronous reluctance machine in the present invention.

FIG. 4 is a radial cross sectional view of a double-stator combined electric machine combining a synchronous reluctance machine and a permanent magnet synchronous machine in the present invention.

FIG. 5 is a radial cross sectional view of a double-stator combined electric machine combining two synchronous reluctance machines in the present invention.

FIG. 6 is an axial cross sectional view of a double-stator combined disc-type electric machine combining two permanent magnet synchronous machines in the present invention.

FIG. 7 is a cross sectional view of a double-stator combined linear electric machine combining two permanent magnet synchronous machines in the present invention.

In the drawings: 1—moving shaft, 2—front end cap, 3—front outer bearing, 4—front rotor support, 5—inner stator, 6—rotor, 7—outer stator, 8—housing, 9—stationary shaft, 10—back rotor support, 11—back outer bearing, 12—retainer ring, 13—inner bearing, 14—back end cap, 15—small back end cap, 16—inner stator winding, 17—outer stator winding, 18—inner air gap permanent magnet, and 19—outer air gap permanent magnet.

### DESCRIPTION OF THE EMBODIMENTS

The present invention is further described below with reference to the accompanying drawings through embodiments.

### Embodiment 1

A novel double-stator combined electric machine suitable for achieving sensorless control of the absolute position of a rotor of the present invention is achieved by the following solution:

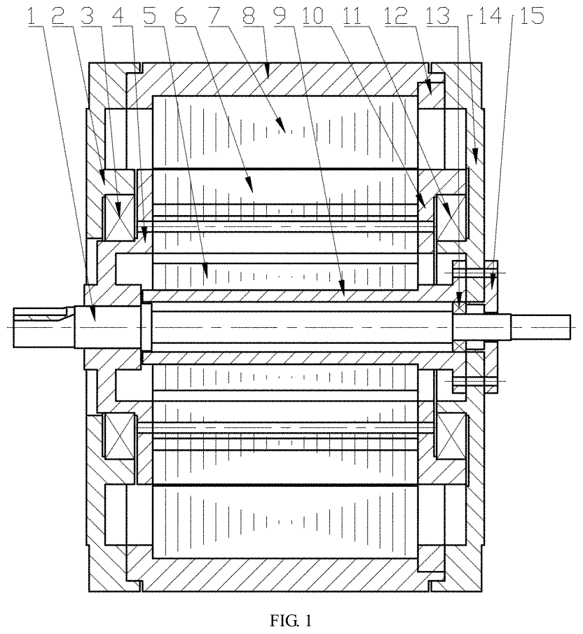

As shown in FIG. 1, an electric machine housing 8 sleeves an outer stator 7. The outer stator is limited by a retainer ring 12 and then is tightly clamped by a front end cap 2 and a back end cap 14. A stationary shaft 9 and a small back end cap 15 are mounted at the center of the back end cap 14. An inner stator 5 is fixed to the stationary shaft 9, the outer stator 7 and the inner stator 5 are concentric, and the above components form a stationary part of the electric machine. A rotor 6 is assembled between the outer stator 7 and the inner stator 5, and forms a rotating part of the electric machine with a moving shaft 1 through a front rotor support 4. The rotating part is isolated from the front end cap 2 through a front outer bearing 3. The rotating part is isolated from the back end cap 14 through a back outer bearing 11 after the rotating part is connected with a back rotor support 10. The moving shaft 1 is isolated from the stationary shaft 9 through an inner bearing 13.

The outer stator 7 and the outer side of the rotor 6 form an outer air-gap electric machine, and the inner stator 5 and the inner side of the rotor 6 form an inner air-gap electric machine. The type of the outer air-gap electric machine and the type of the inner air-gap electric machine may be formed by combining two types of the following electric machines or one type of the following electric machines in pairs: a permanent magnet synchronous machine (a brushless permanent magnet machine), a synchronous reluctance machine, a switched reluctance machine, an electrically excited synchronous machine, a hybrid excitation synchronous machine and the like; or the type of the outer air-gap electric machine and the type of the inner air-gap electric machine may be formed by combining one type of the above electric machines with a reluctance or wound type rotary transformer. Specifically,

(1), the two permanent magnet synchronous machines (brushless permanent magnet machines) are combined;

(2), the permanent magnet synchronous machine (the brushless permanent magnet machine) and the synchronous reluctance machine are combined;

(3), the permanent magnet synchronous machine (the brushless permanent magnet machine) and the switched reluctance machine are combined;

(4), the permanent magnet synchronous machine (the brushless permanent magnet machine) and the electrically excited synchronous machine are combined;

(5), the permanent magnet synchronous machine (the brushless permanent magnet machine) and the hybrid excitation synchronous machine are combined;

(6), the permanent magnet synchronous machine (the brushless permanent magnet machine) and the reluctance or wound type rotary transformer are combined;

(7), the two synchronous reluctance machines are combined;

(8), the synchronous reluctance machine and the switched reluctance machine are combined;

(9), the synchronous reluctance machine and the electrically excited synchronous machine are combined;

(10), the synchronous reluctance machine and the hybrid excitation synchronous machine are combined;

(12), the hybrid excitation synchronous machine and the reluctance or wound type rotary transformer are combined;

(13), the two switched reluctance machines are combined;

(14), the switched reluctance machine and the electrically excited synchronous machine are combined;

(14), the switched reluctance machine and the hybrid excitation synchronous machine are combined;

(15), the switched reluctance machine and the reluctance or wound type rotary transformer are combined;

(16), the two electrically excited synchronous machines are combined;

(17), the electrically excited synchronous machine and the hybrid excitation synchronous machine are combined;

(18), the electrically excited synchronous machine and the reluctance or wound type rotary transformer are combined;

(19), the two hybrid excitation synchronous machines are combined;

(20), the hybrid excitation synchronous machine and the reluctance or wound type rotary transformer are combined.

The numbers of pole pairs p1 and p2 of the two air-gap electric machines meet the following basic rule:

(1), p1≠p2, the greatest common divisors of the p1 and the p2 are equal to 1, and the p1 and the p2 are positive integers;

or,

(2), |m·p1−n·p2|=1, the p1 and the p2 are positive integers, and the m and the n are positive integers;

or,

(3), p1=p2+1 or p1=p2−1, the p1 and the p2 are positive integers;

or,

(4), p1=2, the p2 is any positive odd number or equal to 2, and the p1 is any positive odd number;

or,

(5), p1=1, the p2 is any positive integer or equal to 1, and the p1 is any positive integer.

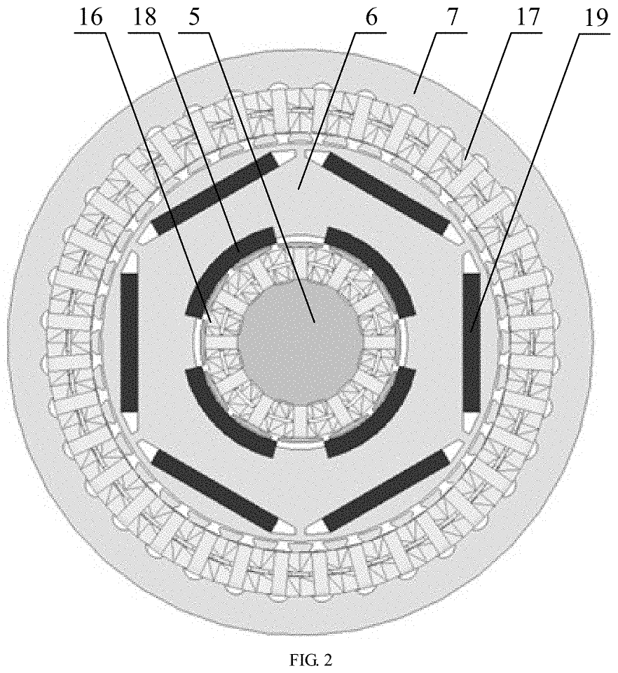

FIG. 2 is a radial cross sectional view of a double-stator combined electric machine combining two permanent magnet synchronous machines. An inner stator winding 16 winds around the inner stator 5. Inner air gap permanent magnets 18 are embedded in the inner side of the rotor 6. An outer stator winding 17 winds around the outer stator 7. Outer air gap permanent magnets 19 are embedded in the outer side of the rotor 6. In FIG. 2, the number of pole pairs of an outer air gap is 3 and the number of pole pairs of an inner air gap is 2.

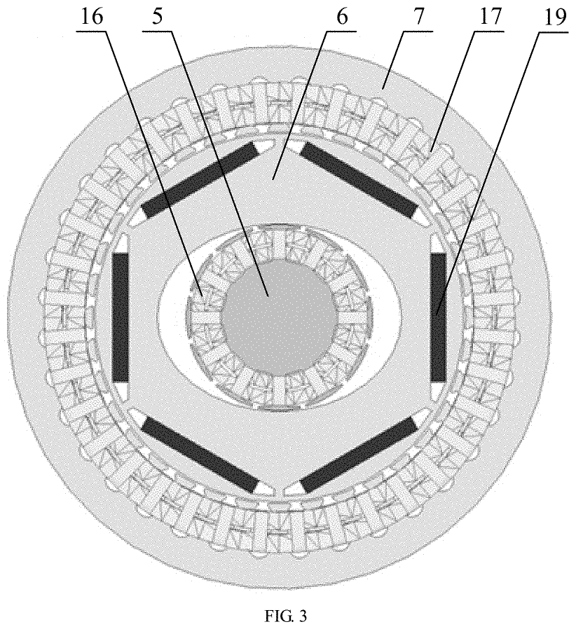

FIG. 3 is a radial cross sectional view of a double-stator combined electric machine combining a permanent magnet synchronous machine and a synchronous reluctance machine. The inner stator winding 16 winds around the inner stator 5. The outer stator winding 17 winds around the outer stator 7. The outer air gap permanent magnets 19 are embedded in the outer side of the rotor 6. In FIG. 3, the number of pole pairs of the outer air gap is 3 and the number of pole pairs of the inner air gap is 2.

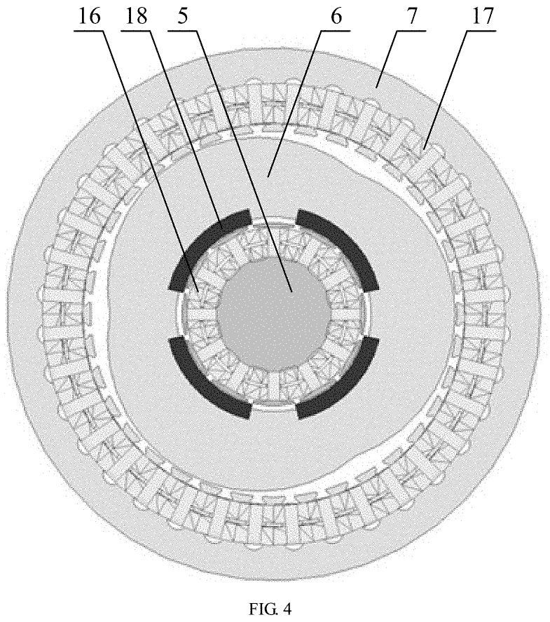

FIG. 4 is a radial cross sectional view of a double-stator combined electric machine combining a synchronous reluctance machine and a permanent magnet synchronous machine. The inner stator winding 16 winds around the inner stator 5. The inner air gap permanent magnets 18 are embedded in the inner side of the rotor 6. The outer stator winding 17 winds around the outer stator 7. In FIG. 4, the number of pole pairs of the outer air gap is 3 and the number of pole pairs of the inner air gap is 2.

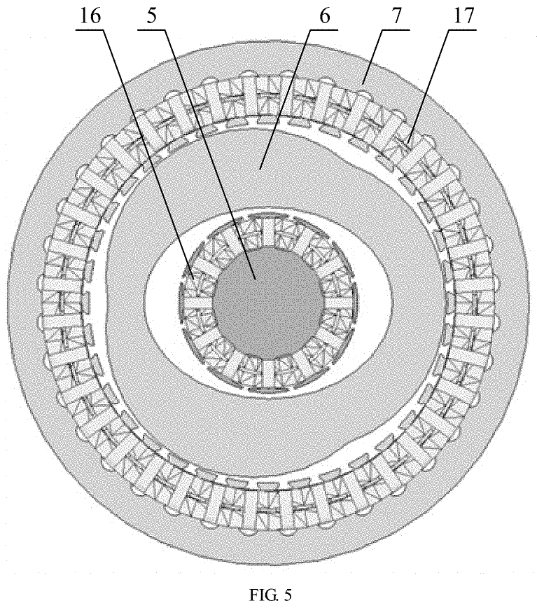

FIG. 5 is a radial cross sectional view of a double-stator combined electric machine combining two synchronous reluctance machines. The inner stator winding 16 winds around the inner stator 5. The outer stator winding 17 winds around the outer stator 7. In FIG. 5, the number of pole pairs of the outer air gap is 3 and the number of pole pairs of the inner air gap is 2.

The type of the electric machine in the embodiment is a synchronous machine. The synchronous machine mainly includes a permanent magnet synchronous machine, a brushless permanent magnet machine, an electrically excited synchronous machine, a hybrid excitation synchronous machine, a synchronous reluctance machine, a switched reluctance machine, and a reluctance or wound type rotary transformer.

Specific electric machine structures in the embodiment are merely for illustrative purposes. Besides, the moving shaft 1 in FIG. 1 has shaft extensions at the front end cap and the back end cap, or may have only one shaft extension. The stationary shaft 9, the back end cap 14 and the small back end cap 15 are separated or integrated. A cooling water channel may be opened in the housing 8 and the stationary shaft 9, respectively. Or, according to the actual temperature increase situation, the water channel is not opened, but an air cooling manner, a natural cooling manner and the like are utilized. The present invention can also utilize variations of the other electric machine structures.

An arrangement manner of the permanent magnets shown in the embodiment is merely for illustrative purposes. Besides the radial arrangement shown in FIG. 2, FIG. 3 and FIG. 4, tangential arrangement and combined arrangement can be also utilized. The combined arrangement comprises U-shaped arrangement, V-shaped arrangement, W-shaped arrangement, and the other radial-tangential combined arrangement.

### Embodiment 2

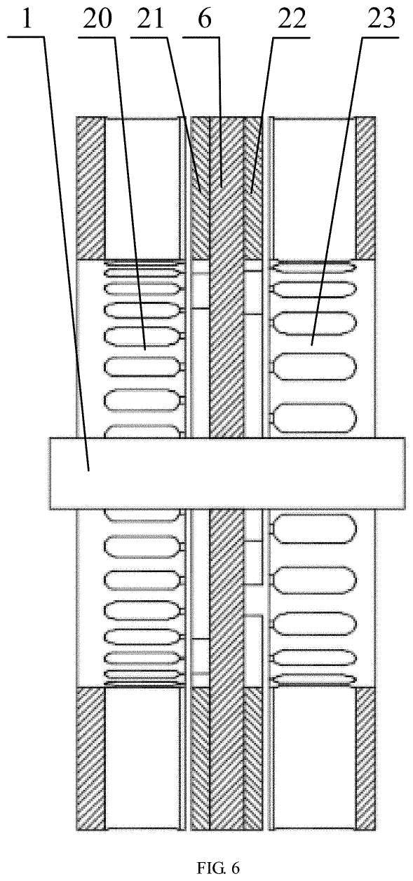

FIG. 6 is an axial cross sectional view of a double-stator combined disc-type electric machine combining two permanent magnet synchronous machines. A left stator winding is wound in a left stator 20. A left air gap permanent magnet 21 is adhered to the left side surface of the rotor 6. A right stator winding is wound in a right stator 23. A right air gap permanent magnet 22 is adhered to the right side surface of the rotor 6. The rotor 6 is clamped between the left stator 20 and the right stator 23. The rotor 6 is driven by the moving shaft 1 to rotate. In FIG. 6, the number of pole pairs of a left air gap is 3 and the number of pole pairs of a right air gap is 2.

### Embodiment 3

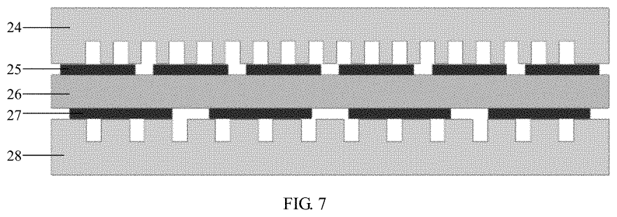

FIG. 7 is a cross sectional view of a double-stator combined linear electric machine combining two permanent magnet synchronous machines. An upper stator winding is wound in an upper stator 24. An upper air gap permanent magnet 25 is adhered to the upper side surface of the rotor 26. A lower stator winding is wound in a lower stator 28. A lower air gap permanent magnet 27 is adhered to the lower side surface of the rotor 26. In FIG. 7, the number of pole pairs of an upper air gap is 3 and the number of pole pairs of a lower air gap is 2.

1-8. (canceled)

9. A double-stator combined electric machine suitable for achieving sensorless control of the absolute position of a rotor,
wherein an outer stator and the outer side of a rotor form an outer air-gap electric machine, and an inner stator and the inner side of the rotor form an inner air-gap electric machine;
the type of the outer air-gap electric machine and the type of the inner air-gap electric machine may be formed by combining two types of the following electric machines or one type of the following electric machines in pairs:
a permanent magnet synchronous machine, a synchronous reluctance machine, a switched reluctance machine, an electrically excited synchronous machine, a hybrid excitation synchronous machine and the like; or
the type of the outer air-gap electric machine and the type of the inner air-gap electric machine may be formed by combining one type of the above electric machines with a reluctance or wound type rotary transformer.

10. The double-stator combined electric machine suitable for achieving sensorless control of the absolute position of a rotor according to claim 9, wherein the numbers of pole pairs p1 and p2 of two air-gap electric machines meet the following basic rule:
(1), p1≠p2, the greatest common divisors of the p1 and the p2 are equal to 1, and the p1 and the p2 are positive integers; or
(2), |m·p1−n·p2|=1, the p1 and the p2 are positive integers, and the m and the n are positive integers.

11. The double-stator combined electric machine suitable for achieving sensorless control of the absolute position of a rotor according to claim 10, wherein the numbers of pole pairs p1 and p2 of two air-gap electric machines meet the following basic rule: p1=p2+1 or p1=p2−1, the p1 and the p2 are positive integers.

12. The double-stator combined electric machine suitable for achieving sensorless control of the absolute position of a rotor according to claim 10, wherein the numbers of pole pairs p1 and p2 of two air-gap electric machines meet the following basic rule: p1=2, the p2 is any positive odd number or equal to 2, and the p1 is any positive odd number.

13. The double-stator combined electric machine suitable for achieving sensorless control of the absolute position of a rotor according to claim 10, wherein the numbers of pole pairs p1 and p2 of two air-gap electric machines meet the following basic rule: p1=1, the p2 is any positive integer or equal to 1, and the p1 is any positive integer.

14. The double-stator combined electric machine suitable for achieving sensorless control of the absolute position of a rotor according to claim 9, wherein the type of the electric machine is a synchronous machine, comprising a permanent magnet synchronous machine, a brushless permanent magnet machine, an electrically excited synchronous machine, a hybrid excitation synchronous machine, a synchronous reluctance machine, a switched reluctance machine, and a reluctance or wound type rotary transformer.

15. The double-stator combined electric machine suitable for achieving sensorless control of the absolute position of a rotor according to claim 10, wherein the type of the electric machine is a synchronous machine, comprising a permanent magnet synchronous machine, a brushless permanent magnet machine, an electrically excited synchronous machine, a hybrid excitation synchronous machine, a synchronous reluctance machine, a switched reluctance machine, and a reluctance or wound type rotary transformer.

16. The double-stator combined electric machine suitable for achieving sensorless control of the absolute position of a rotor according to claim 11, wherein the type of the electric machine is a synchronous machine, comprising a permanent magnet synchronous machine, a brushless permanent magnet machine, an electrically excited synchronous machine, a hybrid excitation synchronous machine, a synchronous reluctance machine, a switched reluctance machine, and a reluctance or wound type rotary transformer.

17. The double-stator combined electric machine suitable for achieving sensorless control of the absolute position of a rotor according to claim 12, wherein the type of the electric machine is a synchronous machine, comprising a permanent magnet synchronous machine, a brushless permanent magnet machine, an electrically excited synchronous machine, a hybrid excitation synchronous machine, a synchronous reluctance machine, a switched reluctance machine, and a reluctance or wound type rotary transformer.

18. The double-stator combined electric machine suitable for achieving sensorless control of the absolute position of a rotor according to claim 13, wherein the type of the electric machine is a synchronous machine, comprising a permanent magnet synchronous machine, a brushless permanent magnet machine, an electrically excited synchronous machine, a hybrid excitation synchronous machine, a synchronous reluctance machine, a switched reluctance machine, and a reluctance or wound type rotary transformer.

19. The double-stator combined electric machine suitable for achieving sensorless control of the absolute position of a rotor according to claim 9, wherein the electric machine topology has a double-stator structure of a radial-magnetic-field electric machine, the direction of magnetic field of the air gap is radial, and the motion manner is rotation; the electric machine topology can be applied to a double-stator and multiple-stator structure of an axial-magnetic-field electric machine, the direction of magnetic field of the air gap is axial, the stators and the rotor are disc-shaped, and the motion manner is rotation; the electric machine topology can be applied to a double-stator single-rotor linear electric machine structure and a planar electric machine structure.

20. The double-stator combined electric machine suitable for achieving sensorless control of the absolute position of a rotor according to claim 10, wherein the electric machine topology has a double-stator structure of a radial-magnetic-field electric machine, the direction of magnetic field of the air gap is radial, and the motion manner is rotation; the electric machine topology can be applied to a double-stator and multiple-stator structure of an axial-magnetic-field electric machine, the direction of magnetic field of the air gap is axial, the stators and the rotor are disc-shaped, and the motion manner is rotation; the electric machine topology can be applied to a double-stator single-rotor linear electric machine structure and a planar electric machine structure.

21. The double-stator combined electric machine suitable for achieving sensorless control of the absolute position of a rotor according to claim 11, wherein the electric machine topology has a double-stator structure of a radial-magnetic-field electric machine, the direction of magnetic field of the air gap is radial, and the motion manner is rotation; the electric machine topology can be applied to a double-stator and multiple-stator structure of an axial-magnetic-field electric machine, the direction of magnetic field of the air gap is axial, the stators and the rotor are disc-shaped, and the motion manner is rotation; the electric machine topology can be applied to a double-stator single-rotor linear electric machine structure and a planar electric machine structure.

22. The double-stator combined electric machine suitable for achieving sensorless control of the absolute position of a rotor according to claim 12, wherein the electric machine topology has a double-stator structure of a radial-magnetic-field electric machine, the direction of magnetic field of the air gap is radial, and the motion manner is rotation; the electric machine topology can be applied to a double-stator and multiple-stator structure of an axial-magnetic-field electric machine, the direction of magnetic field of the air gap is axial, the stators and the rotor are disc-shaped, and the motion manner is rotation; the electric machine topology can be applied to a double-stator single-rotor linear electric machine structure and a planar electric machine structure.

23. The double-stator combined electric machine suitable for achieving sensorless control of the absolute position of a rotor according to claim 13, wherein the electric machine topology has a double-stator structure of a radial-magnetic-field electric machine, the direction of magnetic field of the air gap is radial, and the motion manner is rotation; the electric machine topology can be applied to a double-stator and multiple-stator structure of an axial-magnetic-field electric machine, the direction of magnetic field of the air gap is axial, the stators and the rotor are disc-shaped, and the motion manner is rotation; the electric machine topology can be applied to a double-stator single-rotor linear electric machine structure and a planar electric machine structure.

24. The double-stator combined electric machine suitable for achieving sensorless control of the absolute position of a rotor according to claim 19, wherein the arrangement manner of permanent magnets can be radial arrangement, tangential arrangement and combined arrangement; the combined arrangement comprises U-shaped arrangement, V-shaped arrangement, W-shaped arrangement, the other radial-tangential combined arrangement, and variations of the other electric machine structures.

25. The double-stator combined electric machine suitable for achieving sensorless control of the absolute position of a rotor according to claim 20, wherein the arrangement manner of permanent magnets can be radial arrangement, tangential arrangement and combined arrangement; the combined arrangement comprises U-shaped arrangement, V-shaped arrangement, W-shaped arrangement, the other radial-tangential combined arrangement, and variations of the other electric machine structures.

26. The double-stator combined electric machine suitable for achieving sensorless control of the absolute position of a rotor according to claim 21, wherein the arrangement manner of permanent magnets can be radial arrangement, tangential arrangement and combined arrangement; the combined arrangement comprises U-shaped arrangement, V-shaped arrangement, W-shaped arrangement, the other radial-tangential combined arrangement, and variations of the other electric machine structures.

27. The double-stator combined electric machine suitable for achieving sensorless control of the absolute position of a rotor according to claim 22, wherein the arrangement manner of permanent magnets can be radial arrangement, tangential arrangement and combined arrangement; the combined arrangement comprises U-shaped arrangement, V-shaped arrangement, W-shaped arrangement, the other radial-tangential combined arrangement, and variations of the other electric machine structures.

28. The double-stator combined electric machine suitable for achieving sensorless control of the absolute position of a rotor according to claim 23, wherein the arrangement manner of permanent magnets can be radial arrangement, tangential arrangement and combined arrangement; the combined arrangement comprises U-shaped arrangement, V-shaped arrangement, W-shaped arrangement, the other radial-tangential combined arrangement, and variations of the other electric machine structures.
